(19) United States
(12) Patent Application Publication
(10) Pub. No.: US 2002/0142688 A1
(43) Pub. Date: Oct. 3, 2002

(54) Acrylic elastomer composition, a textile-elastomer composite made therewith, and method of making the same

(76) Inventor: Kirkland W. Vogt, Simpsonville, SC (US)

Correspondence Address: Milliken & Company, P.O. Box 1927, Spartanburg, SC, 29304, US

(21) Appl. No.: 09/818,246

(22) Filed: Mar. 27, 2001

(51) Int. Cl. B32B 3/00; B32B 5/02; D03D 15/00; B32B 5/08; B32B 27/02

(52) U.S. Cl. 442/333; 442/59; 442/211; 442/212; 442/213; 442/218; 442/220; 442/181; 442/327

(57) ABSTRACT

The present invention relates to a process for producing a textile-elastomer composite. The inventive procedure involves (a) producing an elastomer composition of at least three ingredients (an anionically-stabilized waterborne polymer dispersion, an acid-generating chemical, and a cloud-point surfactant); (b) applying the composition onto a porous textile substrate; and (c) heating said coated fabric to cause coagulation of the elastomer composition over the fabric substrate and to dry the resultant composite without destroying the coagulated structure. The resultant composite obtains a suppleness and appearance that is similar to that of leather, while exhibiting improved resistance to ultraviolet radiation and hydrolysis and other types of polymer degradation. The composite may be utilized as upholstery fabric in furniture or in automobiles, in apparel, and the like. The particular composites produced are also contemplated within this invention.

### TECHNICAL FIELD

The present invention relates to a process for producing a textile-elastomer composite whose suppleness and drape resemble leather. The inventive procedure involves (a) producing an elastomer composition of at least three ingredients (a waterborne anionically-stabilized polymer dispersion, an acid-generating chemical, and a cloud-point surfactant); (b) applying the elastomer composition onto a porous textile substrate; and (c) heating the coated textile to cause coagulation of the elastomer over the textile substrate and dry, but not destroy, the coagulated elastomer over the textile. The resultant composite, herein disclosed, exhibits a suppleness that is similar to that of leather and a surface that is stable to ultraviolet light and hydrolysis. The three-ingredient pre-mixture is a long-lasting, shelf-stable composition which will not react until it is exposed to sufficient amounts of heat, thus providing an improvement over the prior art. The particular compositions produced are also contemplated within this invention.

### DISCUSSION OF THE PRIOR ART

Polymer latexes (e.g., acrylates) have been utilized in a variety of ways, most notably as coatings or finishes on fabric surfaces. Such latexes may provide, for example, a barrier to potentially adverse environmental conditions. Furthermore, fabrics having the characteristic suppleness and drape of leather have also been produced through the use of waterborne polymer latexes. Such fabrics provide an alternative to more expensive, genuine leather articles. These coated fabrics must exhibit the suppleness and appearance that are characteristic of genuine leather, and must withstand heavy and repeated use within automobile and furniture upholstery, for example.

Previous polyurethane-based leather substitute products include composites produced through the reaction of a polyurethane latex and an acid-generating chemical (specifically, hydrofluorosilicic salts). Such a composition is disclosed in U.S. Pat. No. 4,332,710, to McCartney, entirely incorporated herein by reference. McCartney teaches heat-activated coagulation of polyurethane latex in conjunction with only an acid-generating chemical, such as salts of hydrofluorosilicic acid. Such a composition and method present some difficulties, primarily using only an acid-generating chemical to provide ionic coagulation. This two-component system often results in a non-uniform distribution in the textile substrate and can form stringy structures, which are unattractive as suede leather substitutes. Of particular concern are the environmental and safety issues associated with the use of hydrofluorosilicic acid salts, which are highly discouraged within the industry but which are patentee's preferred acid-generating chemicals.

Other prior teachings involving polymer latex heat-activated coagulation include U.S. Pat. No. 4,886,702 to Spek et al. The '702 patent discloses a method utilizing a composition comprising a waterborne polymer latex (including polyurethane and acrylate), a cloud-point surfactant coagulant, and a blowing agent, which evolves gas during heating. However, such a composition does not produce preferable leather-like textile products due to the stiff hand that results from the effect of the blowing agent. Second, the preferred blowing agent is freon, which is being phased out of production due to its deleterious environmental impact. Third, the coagulation process requires the addition of acid and/or salt compounds, which have the potential to coagulate the latex mixture prior to contact with a textile substrate, thus resulting in a non-uniform dispersion on the substrate surface. Last, the shelf-life of patentees' composition is, at a maximum, only eight hours in duration, thereby placing certain limitations on manufacturing flexibility.

Furthermore, U.S. Pat. No. 4,171,391, to Parker, teaches polyurethane latex coagulation within an aqueous ionic or acid bath. Because the determining factors are the type and amount of ionic material (or acid) and the rate of diffusion of such a constituent from the bath to the substrate material, such a procedure is difficult to control. As a result, there is a lack of consistent uniform dispersion and coagulation from one textile substrate to another. Particularly with heavier fabric substrates, the necessary contact times may be as long as 30 minutes, translating into high costs for the manufacturer and, ultimately, the consumer.

These shortcomings indicate a need within the industry for improved textile-elastomer composites that are relatively inexpensive to make, that have a more realistic appearance and improved aesthetic qualities, and that have an overall better performance over the prior art.

### SUMMARY

This invention concerns a textile-elastomer composite, and a method of producing this composite, the method comprising the sequential steps of:

(a) providing a textile fabric;

(b) producing a liquid elastomer composition comprising:

(i) a waterborne, anionically-stabilized polymer latex;

(ii) an acid-generating chemical; and

(iii) a cloud-point surfactant;

(c) applying the elastomer composition of (b) to the textile fabric of (a);

(d) heating the coated textile to cause coagulation of said elastomer composition over the textile fabric and to subsequently dry, but not destroy, the coagulated elastomer over the textile.

Also, the invention concerns the elastomer composition of step (b) of the inventive method itself.

It is thus an object of the invention to provide an improved, more aesthetically pleasing fabric-elastomer composite. The term fabric-elastomer composite refers to an article comprised of a textile fabric to which an elastomer composition has been applied. An object of the invention is to provide a composite that has a more realistic, leather-like appearance and texture, thus making such a composite suitable for a number of intended uses. A further object of the invention is to provide a relatively inexpensive method of making such a composite, by providing an elastomer latex with a shelf-life of at least two weeks. Another object of the invention is to provide a method of producing an article which includes environmentally safe, nontoxic, low odor, noncombustible chemicals.

The prior art does not disclose, teach, nor suggest such a specific heat-activated coagulating method utilizing an elastomer composition comprising a waterborne, anionically-stabilized latex, an acid-generating compound, and a cloud-point surfactant. Such an elastomer composition provides a significant advantage over other compositions of the prior art. For instance, the inventive composition has a shelf-life measured in weeks (at least two weeks of stability and non-coagulation after initial admixing) instead of hours at a temperature as high as about 38° C. (100° F.). The coagulation occurs only after exposure to a heat source of sufficient temperature to effectuate such reactivity (such as temperatures greater than about 80° C. or 176° F.). The inventive method and composition described herein provide a high level of coagulant uniformity within composite substrates and also allow uniformity of appearance and performance between many different composites at the large-scale manufacturing level.

The inventive latex composition may be applied using a number of application techniques, including dipping, padding, and spraying. Dipping refers to the immersion of a textile into a processing liquid, typically used in connection with a padding process. Padding may be achieved by passing the textile between squeeze rollers, the bottom of which carries the composition to be applied, or by passing the textile through a bath and subsequently through squeeze rollers, the squeeze rollers acting to remove the excess latex composition. As described, the excess composition may be removed by padding, vacuuming, or other removal means known in the art. Spraying occurs when the textile substrate is passed beneath a row of spray nozzles that apply the composition to the surface of the textile. The inventive composition utilizes a waterborne anionically-stabilized polymer latex, and, more specifically, a latex chosen from the family of acrylics. Acrylic latexes are well known in the art to have improved resistance to ultraviolet light and improved resistance to hydrolysis or other types of polymer degradation, making the composite having an acrylic coating well-suited for automotive and apparel applications.

Yet another improvement available with the inventive method and composition is the use of a strictly aqueous system rather than an organic solvent-based system. These solvent-based systerms are based on coagulation of polyurethane polymers dissolved in dimethylformamide (DMF) with water. These polyurethane polymers are known in the art to be susceptible to hydrolytic degradation at temperatures greater than 130° C. Avoidance of these organic solvents provides less volatility, odor, combustibility, and toxicity as well as increasing the heat stability of the final product. Of particular benefit is the ability to utilize the inventive aqueous composition in conjunction with other compatible aqueous chemical systems used in other areas of textile manufacturing. Such adaptability and compatibility with other textile manufacturing procedures and materials is very important, for example, in reducing the chances of toxic emissions during textile processing.

Finally, and perhaps most importantly, the inventive method and composition impart a soft, fine-structured coagulum leather-like finish to fabrics which is comparable to, if not better than, leather-like finishes produced with organic solvent-borne systems (such as those described in U.S. Pat. No. 4,886,702, noted above). Thus, the inventive method and composition provide the means to produce, in a very safe manner, a fabric-elastomer composite having a desirable suppleness and appearance, which may be used in automotive, home furnishing, and apparel applications.

The term fabric-elastomer composite refers to an article comprised of a textile fabric, to which an elastomer composition has been applied. As noted above, the inventive elastomer composition comprises at least three materials: a waterborne polymer latex, an acid-generating chemical, and a cloud-point surfactant.

An anionically-stabilized polymer latex is an emulsion or dispersion formed from a polymer, an anionic surfactant, and water. Acrylic latex is preferable, but any waterborne anionically-stabilized polymer latex may be used. The preferred latexes are those having at least a 30% solids content, with greater than 50% solids being more preferred. Preferred examples of an anionically-stabilized acrylic latex are Hystretch V29 (50% solids) and Hystretch V-60 (50% solids), available from B. F. Goodrich. In many cases, the latexes contain carboxylic acids or acid salt groups incorporated into the backbone of the acrylic polymer. Such carboxylic acids or acid salt groups are incorporated into the polymer backbone through the use of methacrylic or acrylic acid monomers during polymerization. Similarly, those knowledgeable in the art could incorporate other anionic groups (e.g., those containing sulfur or phosphorous) into the latex backbone during polymerization.

Additionally, anionic surfactants are commonly used to stabilize the latex during polymerization. Examples of suitable anionic surfactants for use in the polymer dispersion include, but are not limited to, poly-acrylic acid copolymers, sodium laurel sulfate, aryl and alkyl benzene sulfonate like, but not limited to, the proprietary Rhodacal DS-10 (from Rhodia). In addition to the anionic surfactant and water, a nonionic surfactant may also be included in the polymer dispersion. Examples of a nonionic surfactant include polyvinyl alcohol and ethoxylated surfactants, such as Pluronic F-68 (from BASF). The waterborne criterion is of utmost importance within this invention primarily to insure that potentially environmentally harmful organic solvents are not present within the elastomer composition.

Also well known in the art is the incorporation of cross-linking agents into the composition in order to help improve the mechanical properties of the polymer (e.g., strength, durability, and abrasion resistance). Many acrylics have cross-linking groups in their molecular backbones, as described above, which facilitate the linking of the polymer chains to affect improved durability and washfastness. A number of different types of cross-linking agents may be added for this purpose, including, but not limited to, (a) formaldehydes, such as melamine formaldehyde or urea formaldehyde; (b) formaldehyde-generating cross-linking agents, such as dimethyl-dihydroxy-ethylene urea (DMDHEU); (c) epoxies, such as WitcoBond from Witco and Epon 828 from Shell; (d) blocked isocyanates, such as Repearl MF from Mitsubishi; and (e) multi-valent ionic cross-linkers, such as zirconium metal salts. Of these, formaldehyde-generating cross-linking agents and blocked isocyanates are most preferred.

The term acid-generating compound denotes a chemical which is not an acid at room temperature, but which produces an acid upon exposure to a heat source. Examples include, but are not limited to, ammonium acid salts like ammonium sulfate, ammonium phosphate, and organic acid esters. One particularly suitable class of compounds that both meet this description and that provide superior results with little or no harmful environmental impact are organic acid esters. Some specific types of these compounds include ethylene glycol diacetate, ethylene glycol formate, diethylene glycol formate, triethyl citrate, monostearyl citrate, a proprietary organic acid ester available from High Point Chemical Corporation under the tradename Hipochem AG-45, and the like. The most preferred compound is ethylene glycol diacetate, available from Applied Textile Technologies under the tradename APTEX™ Donor H-plus.

The term cloud-point surfactant is intended to encompass any surface-active agent that becomes less water soluble upon exposure to higher temperatures. This type of surfactant easily binds with the polymer latex upon gelling and facilitates the uniform coagulation of the latex over the entire contacted textile substrate. Specific surfactants that meet such requirements include poly(ethylene) oxides, poly(ethylene/propylene) oxides, polythio ethers, polyacetals, polyvinylalkyl ethers, organo-polysiloxanes, polyalkoxylated amines, or any derivatives of these listed compounds, with the preferred being polyalkoxylated amines, available from Clariant under the tradename Cartafix U™.

The proportions required within the inventive elastomer composition are based upon the ratio of weights between the latex and each of the remaining components. For instance, ratios between the latex and each of the other components (namely, the acid-generating compound and the cloud-point surfactant) should be in the range of 5:1 to 200:1, with preferred ranges of from about 10:1 to about 50:1. The Examples below further illustrate the utilization of such ranges of weight ratios.

The inventive composition is then applied to the textile substrate, as has been previously described. The composition may be applied to one or both sides of the substrate. Application methods like dipping and padding or dipping and vacuuming result in the composition being distributed throughout the textile, whereas application techniques like spraying tend to result in a higher concentration of elastomer composition on the sprayed surface. For many applications, a uniform concentration of elastomer composition produces the most desired appearance and suppleness. In such applications, dipping or padding techniques are preferred.

Subsequently, the elastomer-coated textile fabric is heated. This heating step generates an acid and gels the cloud-point surfactant, which then uniformly coagulates the inventive latex over the entire substrate. The temperature required to initiate the reaction depends on the particular acid-generating compound utilized. However, in general, the requisite temperature should be at least 80° C.

Alternatively, the coated fabric may also be exposed by heating techniques which do not provide an appreciable loss of moisture to the overall elastomer composition, such as heating by a microwave or radio frequency heating source or by steam heat. An exposure time of from about 1 minute to about 5 minutes may be used.

Yet another alternative is to expose the coated fabric to heating by a convection heat source. Preferably, the heating cycle should cause coagulation of the elatomer composition without appreciable moisture loss. Subsequently, the composite is dried without destroying the coagulation of the elastomer composition. An exposure time of from about 10 seconds to about 10 minutes in a convection oven may be used.

It is in this step that an advantage of using acrylics is realized. The temperatures that are used in this step can be much higher than those used with other polymers (e.g., polyurethane). By using higher temperatures, drying time is reduced and the fabric can be heat-set for dimensional stability while drying. During the drying process, the cross-linking agents that may have been added activate and cross-link the acrylic latex. This cross-linking makes the composite more durable and more washfast.

The textile substrate utilized within the inventive process may comprise any synthetic or natural fiber or blend of such fibers. As merely examples, and not intended as limitations, the textile substrate may be constructed from fibers of polyester, nylon (-6 or -6,6), cotton, polyester/cotton blends, wool, ramie, spandex, and the like. The textile can have a knit, woven, or non-woven construction. The preferred knit substrate is made of polyester, and most preferably polyethylene terephthalate yarns. The preferred woven substrate could be made of cotton, polyester, or a blend of polyester and cotton.

The textile substrate may be treated with dyes, colorants, pigments, ultraviolet absorbers, softening agents, soil redisposition agents, lubricating agents, antioxidants, flame retardants, rheology agents, and the like, either before coating or after, but with a preference for such additions before coating. Within the elastomer composition, there may be incorporated any of the above-listed textile additives, as well as lubricating agents or cross-linking agents. One particularly desired agent is a softening/soil redisposition/lubricating additive Lubril QCX™, available from Rhône-Poulenc. Desirable pigments include PP14-912 and PP14-905 available from Stahl.

It is believed that sanding or napping the textile prior to the application of the elastomeric composition will improve the hand of the textile-elastomer composite and will improve the adhesion between the textile and the composition. The sanding or napping process has been found to impart a suede-like feel on the back of the composite. The composite may be used without additional coatings or other treatments, although transfer or film coating may be included if so desired.

The inventive composite may be utilized as upholstery fabric for furniture or in vehicles; within garments or apparel; or for any other purpose in which a textile-elastomer composite is desired. The composite may be used in residential or commercial upholstery applications. In the automotive or vehicle industry, the composite may be used to create upholstery, door panels, trunkliners, headliners, shift boot covers, and the like. The term “vehicle” is intended to emcompass passenger automobiles, trucks, motorcycles, military transports, boats, airplanes, buses, golf carts, recreational vehicles, and the like. For instance, the composite may be used in the apparel industry to create pants, shirts, jackets, and accessories such as belts, wallets, shoes, handbags, and the like.

### DETAILED DESCRIPTION OF THE PREFERRED EMBODIMENTS

The preferred embodiments of the inventive method and composition are set forth in the following Examples.

### EXAMPLE 1

A 7 ounce/square yard 100% cotton twill fabric was used as the textile substrate. The fabric was dyed and dried. A mixture of 100 grams of Hystretch V-60 (B F Goodrich), 2 grams of APTEX™ Donor H-Plus (Applied Textile Technologies), 2 grams of Cartafix U™ (Clariant), 3 grams of Alkasurf DAP-9 (Rhodia), and 15 grams of Lubril QCX™ (Rhône-Poulenc) were blended together. The fabric was wet with the latex composition and nipped at 80 psi between rollers. The fabric was placed in a convection oven at 360° F. (121° C.) for 3 minutes, where the coating coagulated and dried. The dry polymer pickup was 25% based on weight of fabric. The resulting textile composite had a supple drape and appearance.

### EXAMPLE 2

A 9 ounce/square yard tricot knit polyester fabric with 85% 100/100 textured filament yarn as the face yarn and 15% 20/1 monofilament as the ground yarn was used as the textile substrate. The fabric was dyed, brushed, dried, and sanded on both sides. A mixture of 100 grams of Hystretch V-29 (B F Goodrich), 2 grams of APTEX™ Donor HPlus (Applied Textile Technologies), 2 grams of Cartafix U™ (Clariant), 3 grams of Alkasurf DAP-9 (Rhodia), and 15 grams of Lubril QCX™ (Rhône-Poulenc) were blended together. The fabric was wet with the latex composition and nipped at 80 psi between rollers. The fabric was placed in a convection oven at 360° F. (121° C.) for 3 minutes, where the coating coagulated and dried. The dry polymer pickup was 25% based on weight of fabric. The resulting textile composite felt like leather as characterized by its drape and suppleness.

What is claimed is:

1. A textile-elastomer composite, wherein said textile-elastomer composite is comprised of a textile fabric that has been coated with an elastomer composition, said elastomer composition comprising:
(i) a waterborne, anionically-stabilized acrylic latex;
(ii) an acid-generating chemical selected from the group consisting essentially of at least one organic ester; and
(iii) at least one cloud-point surfactant.

2. The textile-elastomer composite of claim 1, wherein the concentration of said elastomer composition is distributed throughout said textile fabric.

3. The textile-elastomer composite of claim 1, wherein the concentration of said elastomer composition is gradiated throughout said textile fabric, the concentration being highest on the surface or surfaces to which said elastomer composition is applied.

4. The textile-elastomer composite of claim 1 wherein said textile fabric is comprised of fibers selected from the group consisting of natural fibers, synthetic fibers, or blends thereof.

5. The textile-elastomer composite of claim 1 wherein said textile fabric has a knit or non-woven construction.

6. The textile-elastomer composite of claim 5 wherein said textile fabric comprises polyester fibers.

7. The textile-elastomer composite of claim 1 wherein said textile fabric has a woven construction.

8. The textile-elastomer composite of claim 7 wherein said textile fabric comprises cotton fibers, polyester fibers, or blends of cotton and polyester fibers.

9. The textile-elastomer composite of claim 1 for use in vehicle interiors.

10. The textile-elastomer composite of claim 9 for use in vehicle upholstery.

11. The textile-elastomer composite of claim 9 for use as a vehicle headliner.

12. The textile-elastomer composite of claim 9 for use as a vehicle trunkliner.

13. The textile-elastomer composite of claim 1 for use in apparel applications.

14. The textile-elastomer composite of claim 13 for use in pants.

15. The textile-elastomer composite of claim 1 for use in accessories.

16. The textile-elastomer composite of claim 1 for use in residential and commercial upholstery.

17. A method of making a textile-elastomer composite comprising the sequential steps of:
(a) providing a textile fabric;
(b) producing a liquid elastomer composition comprising:
(i) a waterborne, anionically-stabilized polymer latex;
(ii) an acid-generating chemical; and
(iii) at least one cloud-point surfactant;
(c) applying said elastomer composition of (b) to said textile fabric of (a);
(d) heating said textile fabric to cause uniform coagulation of said elastomer composition over said textile fabric and to dry, but not destroy, said coagulated elastomer over said textile fabric.

18. The method of claim 17 wherein said polymer latex comprises an acrylic.

19. The method of claim 17 wherein said elastomer composition is applied by padding.

20. The method of claim 17 wherein said elastomer composition is applied by spraying.

21. The method of claim 17 wherein said elastomer composition of step (b) comprises:
(i) a waterborne, anionically-stabilized polymer latex;
(ii) at least one acid-generating chemical;
(iii) at least one cloud-point surfactant; and
wherein the weight ratio of (i) to (ii) is from about 5:1 to about 200:1 and the weight ratio of (i) to (iii) is from about 5:1 to about 200:1.

22. The method of claim 21 wherein the weight ratio of (i) to (ii) is from about 10:1 to about 50:1 and the weight ratio of (i) to (iii) is from about 10:1 to about 50:1.

23. An elastomer composition comprising:
(i) a waterborne, anionically-stabilized acrylic latex;
(ii) an acid-generating chemical; and
(iii) at least one cloud-point surfactant.

24. The elastomer compositon of claim 23 wherein said acid-generating chemical is selected from the group consisting of at least one organic ester.

25. The elastomer composition of claim 23 wherein said acid-generating chemical is ethylene glycol diacetate.

26. The elastomer composition of claim 23, further comprising at least one cross-linking agent.

27. The elastomer composition of claim 26 wherein said cross-linking agent is selected from the group consisting of formaldehydes, formaldehyde-generating cross-linking agents, epoxies, blocked isocyanates, and multi-valent ionic cross-linking chemicals.

28. The elastomer composition of claim 23 comprising:
(i) a waterborne, anionically-stabilized polymer latex;
(ii) an acid-generating chemical;
(iii) at least one cloud-point surfactant; and
wherein the weight ratio of (i) to (ii) is from about 5:1 to about 200:1 and the weight ratio of (i) to (iii) is from about 5:1 to about 200:1.

29. The composition of claim 28 wherein the weight ratio of (i) to (ii) is from about 10:1 to about 50:1 and the weight ratio of (i) to (iii) is from about 10:1 to about 50:1.

30. A textile-elastomer composite, wherein said textile-elastomer composite is comprised of a textile fabric that has been coated with an elastomer composition, said textile-elastomer composite being exposed to a temperature greater than 130° C.
